(19) United States
(12) Patent Application Publication
(10) Pub. No.: US 2013/0139129 A1
(43) Pub. Date: May 30, 2013

(54) TEST METHOD FOR HANDHELD ELECTRONIC DEVICE APPLICATION

(71) Applicants: FENG-JUNG LEE, TAIPEI CITY (TW); CHING-FENG HSIEH, TAIPEI CITY (TW)

(72) Inventors: FENG-JUNG LEE, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/343,839

(22) Filed: Jan. 5, 2012

(30) Foreign Application Priority Data
Nov. 29, 2011 (TW) 100143786

(51) Int. Cl. G06F 9/44

(52) U.S. Cl. 717/128; 717/127

(57) ABSTRACT

A test method for a handheld electronic device application is introduced. The test method is for testing a handheld electronic device installed thereon with an open operating platform and equipped with a touchscreen by executing a test program installed on the open operating platform to perform a test procedure. The test program identifies selected coordinates displayed on the touchscreen and corresponding to an application, instructs the open operating platform to execute the application based on the selected coordinates, records execution results, and exits an operating interface for the application to execute the application again. The test method cuts labor-related costs, maintains testing stability of the application, and yields reliable test results.

### CROSS-REFERENCE TO RELATED APPLICATION

This non-provisional application claims priority under 35 U.S.C. §119(a) on Patent Application No(s). 100143786 filed in Taiwan, R.O.C. on Nov. 29, 2011, the entire contents of which are hereby incorporated by reference.

### FIELD OF TECHNOLOGY

The present invention relates to testing methods for testing a handheld electronic device, and more particularly, to a testing method for testing an application in a handheld electronic device having a touchscreen.

### BACKGROUND

Due to the prevalence of handheld electronic devices, such as smartphones and tablet computers, a wide variety of handheld electronic devices are commercially available. Another feature of the handheld electronic devices, such as smartphones and tablet computers, is that each of them has a touchscreen.

Various applications can always be installed on a handheld electronic device. Before developing an application, an application developer usually has to gain access to information as to whether the application can operate in a handheld electronic device stably, so as to optimize the compatibility of the application by rewriting and adjusting the application based on the information.

However, the existing art does not teach testing a handheld electronic device to evaluate the reliability and compatibility of an application installed thereon. As a result, it is not until users have discovered plenty of drawbacks of the applications newly launched into the market that the application developers rewrite and adjust the problematic applications hurriedly, thereby incurring plenty of unanticipated losses.

### SUMMARY

It is an objective of the present invention to enable an application under development to be labor-saving and cost-saving and features enhanced stability.

Another objective of the present invention is to test the compatibility between an application and the operating platform.

Yet another objective of the present invention is to enhance the reliability of a test.

In order to achieve the above and other objectives, the present invention provides a test method for an application in a handheld electronic device, applicable to testing a handheld electronic device installed with an open operating platform and equipped with a touchscreen, the testing method comprising the steps of: executing a test program installed on the open operating platform to start a testing procedure; acquiring selected coordinates indicating a position of the application on the touchscreen; executing the corresponding application by the open operating platform based on the selected coordinates; and exiting the operating interface and going back to the step of executing the application by the open operating platform based on the selected coordinates so as to execute the application again, after determining that the open operating platform has executed the application and entered the operating interface of the application.

In an embodiment, the step of executing the corresponding application by the open operating platform based on the selected coordinates further comprises the sub-steps of: enabling the open operating platform to generate a touch control operation execution command and send the touch control operation execution command and the selected coordinates to the touchscreen; executing on the touchscreen a touch selection operation corresponding to the selected coordinates and in response to the touch control operation execution command; and executing the application by the open operating platform in response to the touch selection operation.

In an embodiment, wherein, in the step of exiting the operating interface and going back to the step of executing the application by the open operating platform based on the selected coordinates so as to execute the application again, exiting the operating interface requires one of shutting down the application and causing execution of the application to take place in a background of the open operating platform.

In an embodiment, the testing method further comprises recording an execution failure and going back to the step of executing the application by the open operating platform based on the selected coordinates so as to execute the application again after determining that the open operating platform has failed to enter the operating interface of the application.

In an embodiment, wherein, in the step of recording an execution failure and going back to the step of executing the application by the open operating platform based on the selected coordinates so as to execute the application again after determining that the open operating platform has failed to enter the operating interface of the application, a failure to enter the operating interface of the application means an execution failure or no response from the application, wherein recording an execution failure comprises counting the total number of instances of failure and recording the points in time at which the failure occurs.

In an embodiment, the testing method further comprises the step of acquiring selected coordinates indicating the position of the application on the touchscreen, wherein the selected coordinates to be acquired are specified by a user. Alternatively, the selected coordinates are acquired by searching for a keyword of the application, acquiring the coordinates of the position of the application, and eventually using the acquired coordinates as the selected coordinates.

In an embodiment, the testing method further comprises the step of stopping the testing procedure as soon as a total time of the testing procedure reaches a predetermined number of hours or a predetermined number of loops have been executed.

In an embodiment, the open operating platform is an Android operating platform.

Accordingly, the testing method of the present invention can perform a test on a developed application, wherein the test not only involves starting and shutting down a handheld electronic device repeatedly during a long period of time so as to evaluate the stability of the application installed thereon as well as the compatibility between the application and the operating platform, but also enhances the reliability of the test by being quantified and analyzed.

### BRIEF DESCRIPTION

Objectives, features, and advantages of the present invention are hereunder illustrated with specific embodiments in conjunction with the accompanying drawings, in which:

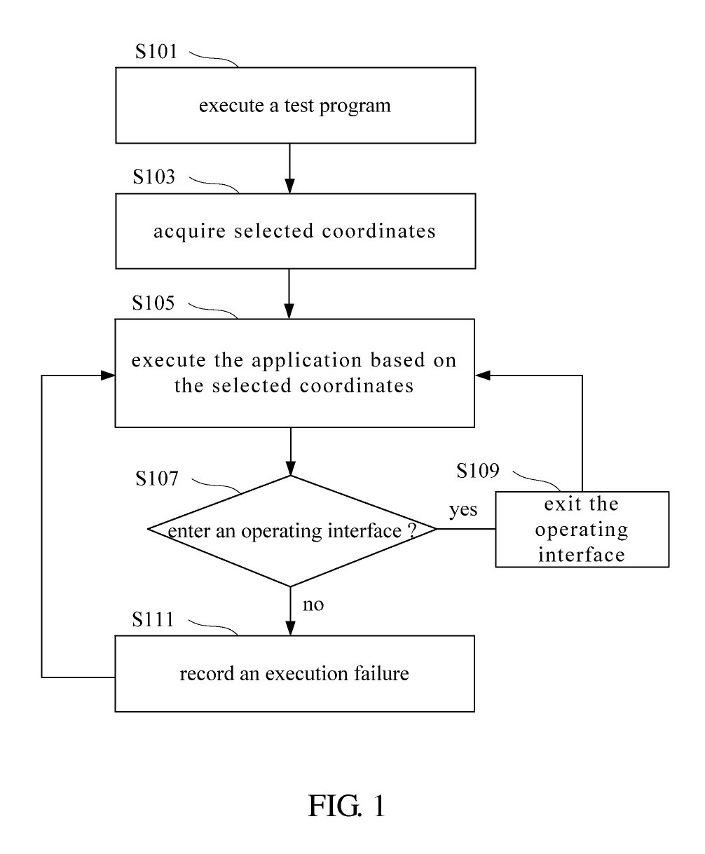

FIG. 1 is a flow chart of a testing method for use with an application in a handheld electronic device according to an embodiment of the present invention;

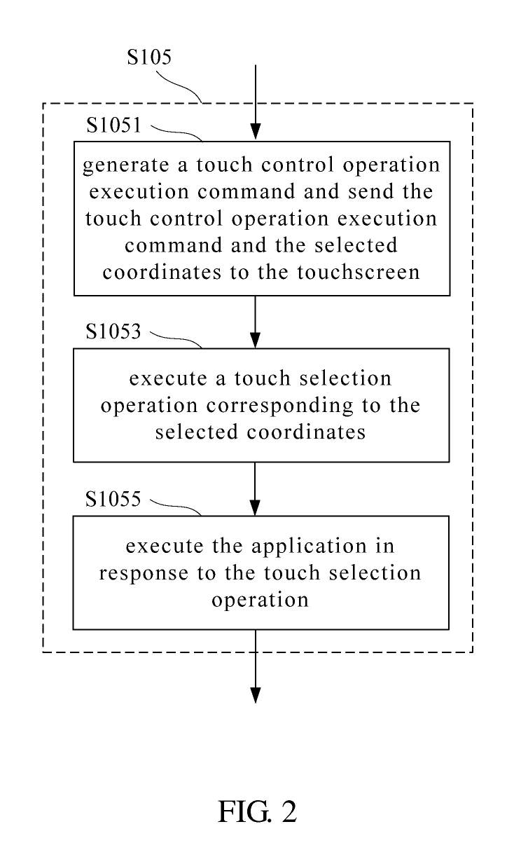

FIG. 2 is a flow chart of execution of an application based on selected coordinates according to an embodiment of the present invention; and

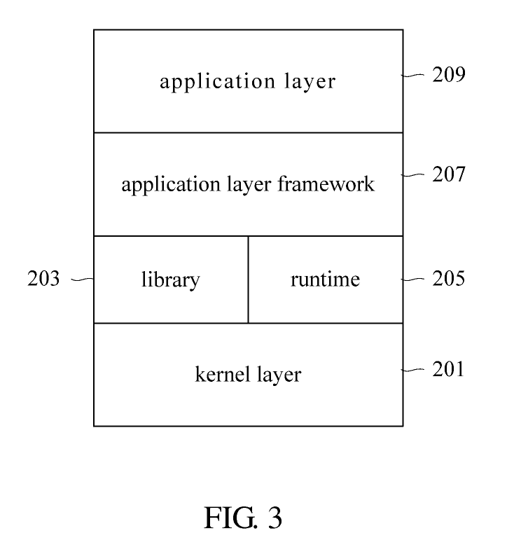

FIG. 3 is a schematic view of functional layers of an Android operating platform.

### DETAILED DESCRIPTION

Referring to FIG. 1, there is shown a flow chart of a testing method for use with an application in a handheld electronic device according to an embodiment of the present invention. The testing method of the present invention is for use with an application in a handheld electronic device installed with an open operating platform and equipped with a touchscreen. The testing method comprises the steps as follows:

First, step S101 involves executing a test program installed on the open operating platform to start a testing procedure. The test program is installed on the open operating platform in advance to facilitate performing a subsequent testing procedure.

Then, step S103 involves acquiring selected coordinates indicating the position of the application on the touchscreen by the test program. The selected coordinates are acquired in the following way: specifying the selected coordinates by an operation worker by hand; or detecting a keyword of an application automatically to search and find the application with the keyword, detect the coordinates of the position of the application, and eventually use the detected coordinates as the selected coordinates.

In step S105, the test program enables the open operating platform to execute the corresponding application based on the selected coordinates. Referring to FIG. 2, in an embodiment, step S105 further comprises: sub-step (S1051) in which the test program enables the open operating platform to generate a touch control operation execution command and send the touch control operation execution command and the selected coordinates to the touchscreen; sub-step (S1053) executing on the touchscreen a touch selection operation corresponding to the selected coordinates and in response to the touch control operation execution command; and sub-step (S1055) executing the application by the open operating platform in response to the touch selection operation.

Step S107 involves determining whether the open operating platform has executed the application and entered an operating interface of the application. An affirmative determination causes the process flow of the testing method of the present invention to go to step S109. A negative determination causes the process flow of the testing method of the present invention to go to step S111.

Step S109 involves exiting the operating interface and going back to the step S105 of executing the application by the open operating platform based on the selected coordinates so as to execute the application again.

Step S111 involves recording an execution failure and going back to step S105.

The testing method comprising the aforesaid steps enables the application to be started and shut down repeatedly by loop, so as to evaluate the operation of the application in the aforesaid strict condition.

In step S109, exiting the operating interface has two implications: first, shutting down the application; second, causing the execution of the application to take place in the background of the open operating platform. In this regard, exit of an application typically occurs in one of the two possible modes: exiting fully (i.e., a shutdown), and exiting from a touchscreen but still being executed in a background program. The testing method in an embodiment of the present invention enables the operation worker to set an intended mode of the testing method. Alternatively, the aforesaid two modes can work in conjunction. For example, performing the exit of an application in the first mode (a shutdown of the application) for a specific number of times is followed by performing the exit of the application in the second mode (background execution) for a specific number of times.

Regarding the negative determination made in step S107, a failure to enter the operating interface of the application means an execution failure or no response from the application. In step S111, recording an execution failure comprises counting the total number of instances of failure and recording the points in time at which the failure occurs.

In an embodiment of the present invention, the testing method is applicable to a handheld electronic device installed with an Android operating platform. FIG. 3 is a schematic view of functional layers of an Android operating platform. The Android operating platform comprises a kernel layer 201, a library 203, a runtime 205, an application layer framework 207, and an application layer 209. Since the Android operating platform is published technology, the details of the operation of its functional layers are not described hereunder for the sake of brevity. In an embodiment of the present invention, the test program is installed on the application layer 209, such that the Android operating platform performs the steps of: simulating events of touching the selected coordinates on the screen by means of the application layer framework 207, the library 203, and the runtime 205; sending the touch control operation execution command and the selected coordinates to a screen driver in the kernel layer 201; executing the selected application; feeding back the execution operation to an application on an upper layer; acquiring and sending an execution result of the application to the test program by the Android operating platform through the application layer framework 207, the library 203, the runtime 205, and the kernel layer 201; determining and recording the execution result by the test program so as to start the loop-type stress test, wherein the operation worker sets the total number of loops to be executed or sets a predetermined number of hours for the test process to last; and outputting a report of the test result.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A test method for an application in a handheld electronic device, applicable to testing a handheld electronic device installed with an open operating platform and equipped with a touchscreen, the testing method comprising the steps of:
executing a test program installed on the open operating platform to start a testing procedure;
acquiring selected coordinates indicating a position of the application on the touchscreen;
executing the corresponding application by the open operating platform based on the selected coordinates; and
exiting the operating interface and going back to the step of executing the application by the open operating platform based on the selected coordinates so as to execute the application again, after determining that the open operating platform has executed the application and entered the operating interface of the application.

2. The test method of claim 1, wherein the step of executing the corresponding application by the open operating platform based on the selected coordinates further comprises the sub-steps of:
enabling the open operating platform to generate a touch control operation execution command and send the touch control operation execution command and the selected coordinates to the touchscreen;
executing on the touchscreen a touch selection operation corresponding to the selected coordinates and in response to the touch control operation execution command; and
executing the application by the open operating platform in response to the touch selection operation

3. The test method of claim 1, wherein, in the step of exiting the operating interface and going back to the step of executing the application by the open operating platform based on the selected coordinates so as to execute the application again, exiting the operating interface requires one of shutting down the application and causing execution of the application to take place in a background of the open operating platform.

4. The testing method of claim 1, further comprising recording an execution failure and going back to the step of executing the application by the open operating platform based on the selected coordinates so as to execute the application again after determining that the open operating platform has failed to enter the operating interface of the application.

5. The test method of claim 4, wherein, in the step of recording an execution failure and going back to the step of executing the application by the open operating platform based on the selected coordinates so as to execute the application again after determining that the open operating platform has failed to enter the operating interface of the application, a failure to enter the operating interface of the application means an execution failure or no response from the application.

6. The test method of claim 5, wherein recording an execution failure comprises counting the total number of instances of failure and recording the points in time at which the failure occurs.

7. The test method of claim 1, wherein, in the step of acquiring selected coordinates indicating the position of the application on the touchscreen, the selected coordinates to be acquired are specified by a user.

8. The test method of claim 1, wherein, in the step of acquiring selected coordinates indicating the position of the application on the touchscreen, the selected coordinates are acquired by searching for a keyword of the application, acquiring the coordinates of the position of the application, and eventually using the acquired coordinates as the selected coordinates.

9. The testing method of claim 1, further comprising the step of stopping the testing procedure as soon as a total time of the testing procedure reaches a predetermined number of hours or a predetermined number of loops have been executed.

10. The testing method of claim 1, wherein the open operating platform is an Android operating platform.
